(19) United States
(12) Patent Application Publication
(10) Pub. No.: US 2011/0072941 A1
(43) Pub. Date: Mar. 31, 2011

(54) HAND TOOL WITH AN ADJUSTING DEVICE

(76) Inventor: Ming-Ching Tsai, Taichung City (TW)

(21) Appl. No.: 12/568,716

(22) Filed: Sep. 29, 2009

(51) Int. Cl. B25B 23/16; B25G 1/06

(52) U.S. Cl. 81/177.8; 81/177.7

(57) ABSTRACT

A hand tool with an adjusting device includes a tool head having an engaging portion formed thereon. A handle is pivotally connected to the engaging portion. The handle has a chamber and a cavity defined therein. An adjusting device includes an engaging member and a spring movably received in the chamber. The spring tends to urge the engaging member toward the tool head. The adjusting device includes a positioning member and an elastomer movably received in the cavity. The positioning member has a recess defined therein and an inclined surface formed thereon. Accordingly, the tool head is able to pivotally rotate relative to the handle for adjusting to a desired angle.

### BACKGROUND OF THE INVENTION

1. Field of the Invention

The present invention relates to a hand tool with an adjusting device, and more particularly to a hand tool having an adjusting device for adjusting a tool head to a desired angle.

2. Description of Related Art

A conventional pivot tip of a hand tool in accordance with the prior art comprises a hand grasp member, an elongated member aligned with said hand grasp member, a work piece shaft mounted in relation to the elongated member for relative movement therewith between a retracted position and an extended position, and a pivot tip member between a first working position and a second working position. The pivot tip member is substantially normal to the longitudinal axis of the work piece shaft in the second working position. First holding means hold said work piece shaft in said extended position, and second holding means hold the pivot tip member in the first working position in axial alignment with the work piece shaft. Therefore, the pivot tip member includes a socket member and an axial bore passing through the socket member. The axial bore is axially aligned with the work piece shaft in the first working position or the second position. A tool is received in the axial bore for abutting against the work piece shaft when in the first working position or the second position.

However, the prior art suffers from several disadvantages. Due to the connecting structure between the pivot tip and the elongated shank, the work piece shaft has the relative retracting or extending movement. So the work piece shaft is broken easily if a strong force is applied. Moreover, the pivot tip of a hand tool only has two work positions which are parallel and perpendicular to the hand grasp member. Therefore, the pivot tip a hand tool is inconvenient to be used.

The present invention has arisen to mitigate and/or obviate the disadvantages of the conventional hand tool.

### SUMMARY OF THE INVENTION

The main objective of the present invention is to provide an improved hand tool with an adjusting device.

To achieve the objective, the hand tool with an adjusting device includes a tool head having a driving portion formed on one end thereof and an engaging portion formed on the other end thereof opposite to the driving portion.

A handle is pivotally connected to the tool head. The handle has a first ear and a second ear oppositely formed on a first end thereof and extending upwardly. The engaging portion of the tool head is located between the first ear and the second ear. The engaging portion of the tool head is pivotally rotatably connected to the first and the second ears. The handle has a chamber axially defined in the first end thereof and located between the first and the second ears. The handle has a connecting hole coaxially defined in a bottom of the chamber. An inner diameter of the connecting hole is relatively smaller than an inner diameter of the chamber. The handle has a cavity laterally defined in the first end thereof and communicates with the chamber via the connecting hole.

An adjusting device is received in the handle. The adjusting device includes an engaging member movably received in the chamber for engaging with the engaging portion of the tool head. The engaging member has an elongated portion extending from a bottom thereof and partially received in the connecting hole. A spring is compressibly received in the chamber and wound around the elongated portion for tending to urge the engaging member toward the tool head. The spring has two ends respectively abutting against the engaging member and the bottom of the chamber around the connecting hole.

Furthermore, the adjusting device includes a positioning member movably received in the cavity. The elongated portion passes through the connecting hole for engaging with the positioning member. The positioning member has a recess defined therein and facing the engaging member. The positioning member has an inclined surface located beside the recess and facing the engaging member. The inclined surface inclines downwardly to an edge of the recess. The positioning member has a receiving hole defined in a first end thereof. An elastomer is compressibly received in the receiving hole. The elastomer has two ends respectively abutting against an inner periphery of the cavity and the positioning member.

When the recess is aligned with the chamber and the connecting hole, the engaging member is able to be retracted. The tool head is free to pivotally rotate relative to the handle and adjusted to a desired angle. When the inclined surface on the positioning member is aligned with the chamber and engages with the elongated portion, the engaging member is urged upwardly to engage with the engaging portion of the tool head, such that the tool head is fastened.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a hand tool with an adjusting device in accordance with the present invention;

FIG. 2 is an assembled perspective view of the hand tool with an adjusting device in accordance with the present invention;

FIG. 3 is a partial cross-sectional view of the hand tool with an adjusting device in accordance with the present invention;

FIGS. 4-5 are operational partial cross-sectional view of the hand tool with an adjusting device in accordance with the present invention; and

FIG. 6 is a partial cross-sectional view of the hand tool with an adjusting device in accordance with the present invention when the hand tool with a tool bit is operated.

### DETAILED DESCRIPTION OF THE INVENTION

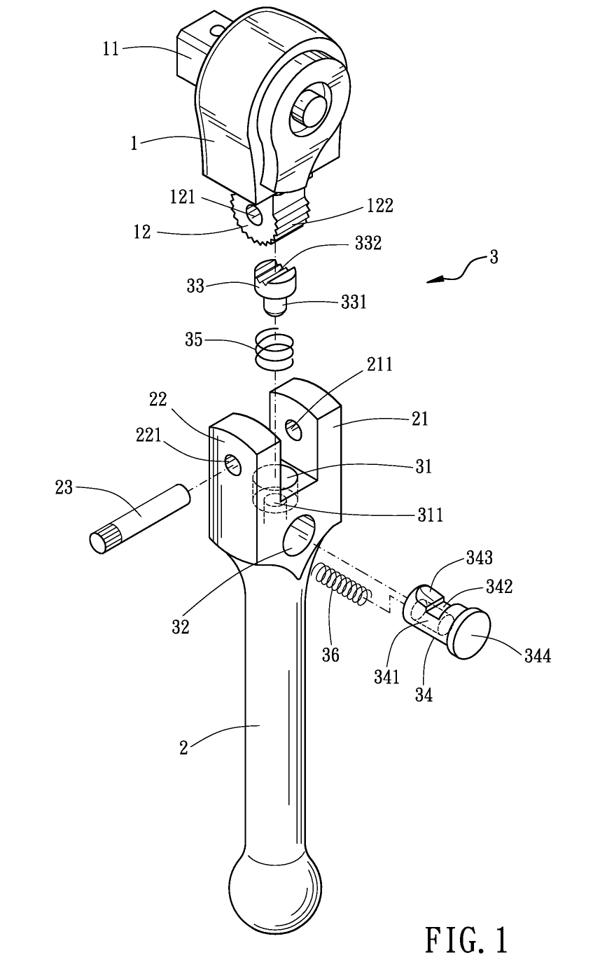

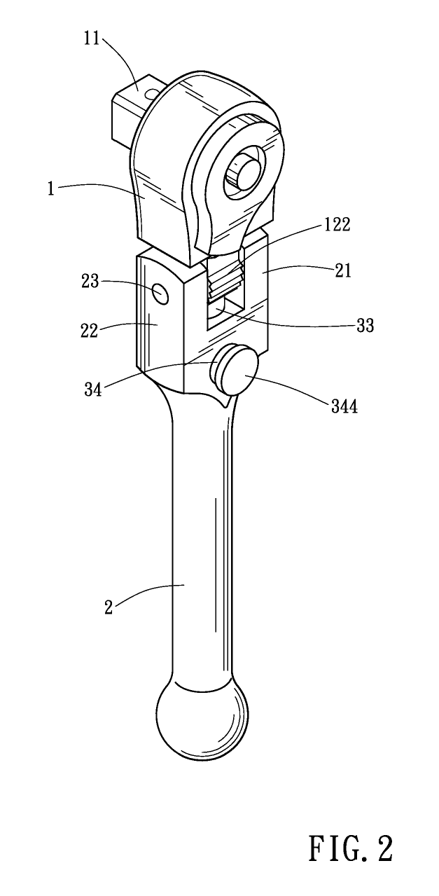

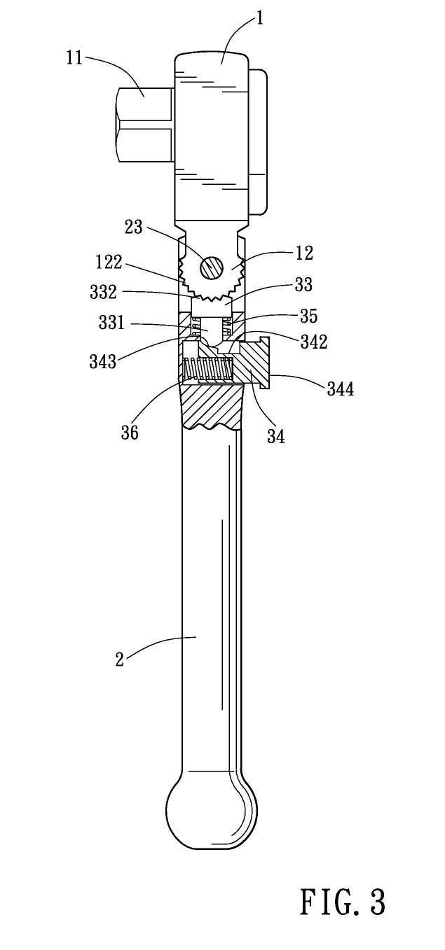

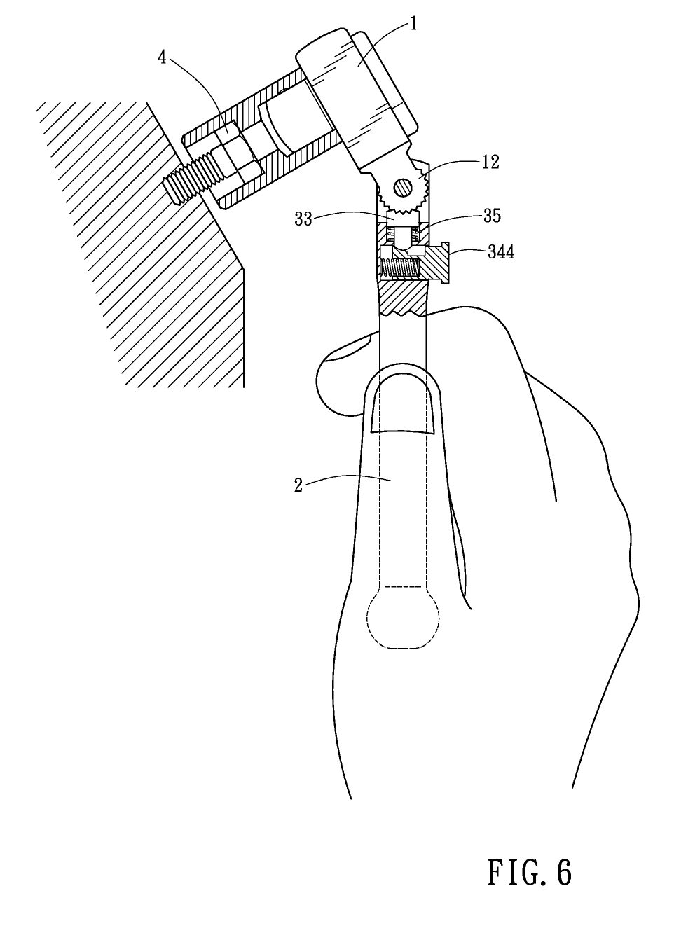

Referring to the drawings and initially to FIGS. 1-3, a hand tool with an adjusting device in accordance with a preferred embodiment of the present invention comprises a tool head 1 having a driving portion 11 formed on one end thereof for connecting a tool bit 4 (shown in FIG. 6). The driving portion 11 is a ratchet head. The tool head 1 has an engaging portion 12 formed on the other end thereof opposite to the driving portion 11. The engaging portion 12 is in a cylindrical shape. The engaging portion 12 has a fastening hole 121 defined therein and laterally extending therethrough. The engaging portion 12 has a series of first teeth 122 formed on an outer periphery thereof.

A handle 2 is pivotally connected to the tool head 1. The handle 2 has a first ear 21 and a second ear 22 oppositely formed on a first end thereof and extending upwardly. Each of the first and the second ears 21, 22 has a through hole 211, 221 laterally defined therein. The engaging portion 12 of the tool head 1 is located between the first ear 21 and the second ear 22. The fastening hole 121 is coaxial with the two through holes 211, 221. A bolt 23 passes through the two through holes 211, 221 and the fastening hole 121, such that the engaging portion 12 of the tool head 1 pivotally connects to the handle 2 and is able to rotate relative to the handle 2.

The handle 2 has a chamber 31 axially defined in the first end thereof and located between the first 21 and the second ears 22. The handle 2 has a connecting hole 311 coaxially defined in a bottom of the chamber 31. An inner diameter of the connecting hole 311 is relatively smaller than an inner diameter of the chamber 31. The handle 2 has a cavity 32 laterally defined in the first end thereof and communicates with the chamber 31 via the connecting hole 311.

The hand tool with an adjusting device further comprises an adjusting device 3 received in the handle 2. The adjusting device 3 includes an engaging member 33 movably received in the chamber 31. The engaging member 33 has a series of second teeth 332 formed on a top thereof and extending toward the engaging portion 12 for selectively engaging with first teeth 121. The engaging member 33 has an elongated portion 331 extending from a bottom thereof and partially received in the connecting hole 311. A spring 35 is compressibly received in the chamber 31 and wound around the elongated portion 331 for tending to urge the engaging member 33 toward the tool head 1. The spring 35 has two ends respectively abutting against the engaging member 33 and the bottom of the chamber 31 around the connecting hole 311.

Furthermore, the adjusting device 3 includes a positioning member 34 movably received in the cavity 32. The elongated portion 331 passes through the connecting hole 311 for engaging with the positioning member 34. The positioning member 34 has a recess 342 defined therein and facing the engaging member 33. The positioning member 34 has an inclined surface 343 located beside the recess 342 and facing the engaging member 33. The inclined surface 343 inclines toward an edge of the recess 342. The positioning member 34 has a receiving hole 341 defined in a first end thereof and a pressing plate 344 formed on a second end thereof opposite to the first end. The pressing plate 344 is in a round shape and projected from the cavity 32.

An elastomer 36 is compressibly received in the receiving hole 341. The elastomer 36 has two ends respectively abutting against an inner periphery of the cavity 32 and an inner periphery of the receiving hole 341 in the positioning member 34. Therefore, when pressing the pressing plate 344, the elastomer 36 is compressed and the positioning member 34 moves along the cavity 32.

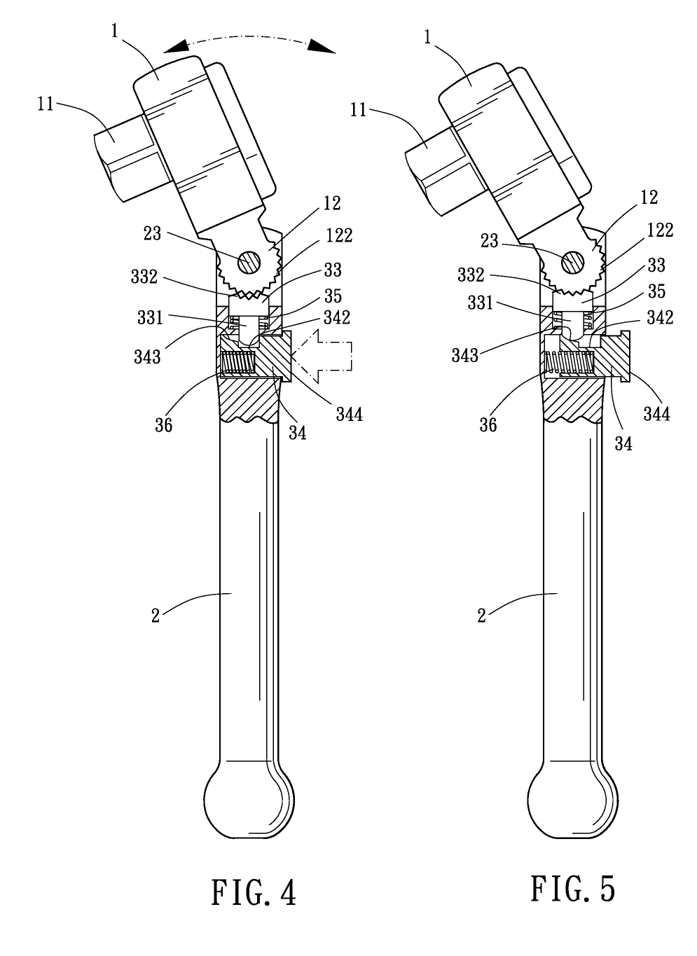

The operation of the hand tool with an adjusting device in accordance with the present invention will be described in detailed below. As shown in FIGS. 4-5, first of all, the recess 342 in the positioning member 34 is aligned with the chamber 31 and the connecting hole 311 by pressing the pressing portion 344 of the positioning member 34, and the tool head 1 is able to rotate relative to the handle 2. When adjusting, the first teeth 122 disengage with the second teeth 332. The engaging member 33 is retracted and the elongated portion 331 is downwardly inserted into the recess 342. Because the spring 35 tends to urge the engaging member 33 toward the tool head 1, the second teeth 332 engage with the first teeth 122 again. Therefore, the first teeth 122 contacts with the second teeth 332 to make a sound for reminding a user of the number of passed teeth.

As the tool head 1 is at a desire angle, the inclined surface 343 on the positioning member 34 is aligned with the chamber 31 and the connecting hole 311 for engaging with the elongated portion 331. The second teeth 332 of the engaging member 33 are urged upwardly to engage with the first teeth 122 of the engaging portion 12, such that the tool head 1 is fastened by the adjusting device 3.

Although the invention has been explained in relation to its preferred embodiment, it is to be understood that many other possible modifications and variations can be made without departing from the spirit and scope of the invention as hereinafter claimed.

What is claimed is:

1. A hand tool with an adjusting device comprising:
a tool head having a driving portion formed on one end thereof and an engaging portion formed on the other end thereof opposite to the driving portion;
a handle pivotally connected to the tool head, the handle having a first ear and a second ear oppositely formed on a first end thereof and extending upwardly, the engaging portion of the tool head located between the first and the second ears, the engaging portion pivotally rotatably connected to the first and the second ears, the handle having a chamber axially defined in the first end thereof and located between the first and the second ears, the handle having a cavity laterally defined in the first end thereof and communicating with the chamber; and
an adjusting device received in the handle, the adjusting device comprising:
an engaging member movably received in the chamber for engaging with the engaging portion of the tool head;
a spring compressibly received in the chamber for tending to urge the engaging member toward the tool head, the spring having two ends respectively abutting against the engaging member and a bottom of the chamber;
a positioning member movably received in the cavity for abutting against the engaging member, the positioning member having a recess defined therein and facing the engaging member, the positioning member having an inclined surface located beside the recess and facing the engaging member; and
an elastomer compressibly received in the cavity, the elastomer having two ends respectively abutting against an inner periphery of the cavity and the positioning member;
wherein when the recess in the positioning member is aligned with the chamber, the engaging member is able to be retracted and the tool head is free to pivotally rotate relative to the handle; when the inclined surface on the positioning member is aligned with the chamber and engages with the engaging member, the engaging member is urged upwardly to engage with the engaging portion of the tool head such that the tool head is fastened.

2. The hand tool with an adjusting device as claimed in claim 1, wherein the engaging member has an elongated portion extending from a bottom thereof and wound around by the spring, the positioning member having a receiving hole defined in a first end thereof for receiving the elastomer.

3. The hand tool with an adjusting device as claimed in claim 1, wherein the handle has a connecting hole coaxially defined in a bottom of the chamber and communicating with the cavity, an inner diameter of the connecting hole being relatively smaller than an inner diameter of the chamber, wherein the spring abuts against the bottom of the chamber around the connecting hole.

4. The hand tool with an adjusting device 1 as claimed in claim 2, wherein the handle has a connecting hole coaxially defined in the bottom of the chamber and communicating with the cavity, an inner diameter of the connecting hole being relatively smaller than an inner diameter of the chamber, wherein the spring abuts against the bottom of the chamber around the connecting hole and the elongated portion passes through the connecting hole for engaging with the positioning member.

5. The hand tool with an adjusting device as claimed in claim 1, wherein the inclined surface inclines toward an edge of the recess.

6. The hand tool with an adjusting device as claimed in claim 1, wherein the positioning member has a pressing plate formed on a second end thereof opposite to the first end, the pressing plate being in a round shape such that the positioning member moves along the cavity by pressing the pressing plate.
